(19) United States
(12) Patent Application Publication
(10) Pub. No.: US 2010/0036694 A1
(43) Pub. Date: Feb. 11, 2010

(54) Method and System for Providing a Customized Publicaiton

(75) Inventors: Greg D. Schroeder, Oakland, CA (US); Kamran Mohsenin, Ross, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: TasteBook Inc., Berkeley, CA (US)

(21) Appl. No.: 12/189,689

(22) Filed: Aug. 11, 2008

(51) Int. Cl. G06F 17/30; G06F 7/06; H04L 9/32

(52) U.S. Cl. 705/7; 707/5; 726/7; 707/E17.016

(57) ABSTRACT

Methods and systems for providing customized publications, such as cookbooks are disclosed. The methods and systems display a list of recipes associated with a library of recipes selected by a user and receive from a user a selection set of one or more recipes from the list of recipes. The methods and systems also retrieve the one or more recipes in the selection set from a content database, assemble a customized cookbook having a plurality of pages that include the retrieved one or more recipes, and send an order for printing the customized cookbook.

### BACKGROUND OF THE INVENTION.

1. Field of the Invention

The present invention is related to user customized publications, and is particularly directed to methods and systems for providing customized cookbooks.

2. Background

Cooking, which is broadly meant to encompass all types of food preparation and handling, has achieved new levels of popularity due, in part, to the widespread availability of ingredients from around the world along with the much broader exposure of the general population to different culinary styles. Cookbooks containing recipes and other types of food-related information have been in use for hundreds of years, and the popularity of cookbooks, many of which are highly specialized, has never been greater. While existing traditional cookbooks are useful, they have a variety of limitations.

Most people who have an interest in cooking typically rely on a collection of cookbooks, and frequently have a separate collection of individual recipes. Most individuals use only a small percentage of the recipes found in a published cookbook, and often modify the recipes to suit their individual dietary needs or tastes. Some cookbooks have blank sections to allow users to add notes or paste photographs onto recipe pages thereby allowing supplementation what is published. Many users supplement their cookbook collections with individual recipes they obtain from a variety of sources, including recipes from family and friends, magazines and newspapers, food packages, etc.

Over the last decade the explosive growth of the internet has seen the development of many food-related websites which offer recipes “on-line.” Some of these sites are highly sophisticated, providing users with access to thousands of recipes and other food-related information, along the capacity to maintain and share favorite recipes and to store user-specific modifications to favorite recipes. One such site, for example, is www.epicurious.com.

The widespread availability of recipes and other food-related information, both hardcopy and online, and the relatively greater use of such information from all of these sources makes the task of organizing and maintaining the information challenging. Accordingly, it is the overall object of the present invention to simplify the task of managing such information. Embodiments of the present disclosure address these and other problems and objects, individually and collectively.

### SUMMARY OF THE INVENTION

The present invention is broadly directed to various aspects of providing methods and systems for providing customized publications, and more specifically, customized cookbooks and cookbook inserts.

In one embodiment, a host site provides options to users for creating and customizing cookbooks incorporating published recipes and/or user-created recipes. After logging onto the host site, users organize and select recipes to be incorporated into customized cookbooks. The recipes may be selected from recipe libraries, which can either be stock libraries, user created libraries, or a combination of the two. Preferably, users can create their own libraries of recipes, import libraries from one or more remote websites, share libraries with other users, or select predefined libraries. The recipe libraries are preferably stored in one or more databases associated with the host site. Users then select recipes from their libraries for incorporation into a customized cookbook.

Users may import to the host site libraries that were previously created and stored on other websites. According to another aspect of the present invention, the process of library retrieval, processing and storage is highly automated and adapted to facilitate the later production of a customized cookbook.

In one aspect of the invention, the host site retrieves recipes from a remote site and parses the information in the recipes, for example, to determine the ingredients, the amounts of the ingredients, the nutritional content, and other suitable information related to recipes. Likewise, the host site parses recipes that users upload to their libraries. The host site uses this parsed information for a variety of purposes, for example, to assign each recipe to a chapter or section in the cookbook or to facilitate the automatic generation of shopping lists.

In another aspect of the invention, the host site provides users tools to customize their cookbooks. For example, users can choose to have notes or images associated with one or more recipes which are included at the time of printing. Likewise, users can be given the option of moving recipes from an initially assigned chapter to another. Preferably, the host site allows users to preview their customized cookbooks by “flipping” through accurately rendered images of the pages displayed on the host site.

In accordance with another aspect of the present invention, users purchase “recipe allowances” when logged onto the host site. In one embodiment, recipe allowances grants users the right to incorporate a predetermined number of recipes into their customized cookbooks. According to a further aspect of the invention, users can use all their recipe allowances at the time the customized cookbook is ordered, or some number of the recipe allowances can be saved for use in the future. In this connection, saved recipe allowances can be used to order recipes at a later date for supplementing an existing customized cookbook, as described hereinbelow. Moreover, users can provide all or a portion of their recipe allowances to other users, for example, as gifts.

In a further aspect of the present invention, the batches for printing customized cookbooks and/or supplemental recipe orders (“recipe packs”), comprising a plurality of individual user orders, are optimized to facilitate printing. The customized cookbooks and/or recipe packs are printed in accordance with the optimized batches and each users order is assembled, bound, and delivered to the user or a person designated by the user.

Another aspect of the invention is directed to a method of displaying a list of recipes associated with a library selected by a user and receiving from a user a selection set of one or more recipes from the list of recipes. The method also includes retrieving the one or more recipes in the selection set from a content database, assembling a customized cookbook having a plurality of pages that include the retrieved one or more recipes, and sending an order for printing the customized cookbook.

Another embodiment of the invention is directed to a method of selecting a library of recipes and choosing one or more recipes from a list of recipes associated with the library of recipes to form a selection set, wherein the one or more recipes in the selection set are stored in a content database. The method further includes ordering a customized cookbook having a plurality of pages that includes the one or more recipes retrieved from the content database.

Another embodiment of the invention is directed to a system including a host site server computer and a services server computer in communication with the host site server computer. The host site server computer has a first computer readable medium having code for displaying a list of recipes associated with a library selected by a user, receiving from a user a selection set of recipes from the list of recipes, and retrieving the recipes in the selection set from a content database. The services server computer has a second computer readable medium having code for retrieving the one or more recipes in the selection set from a content database, assembling a customized cookbook having a plurality of pages that include the retrieved one or more recipes, and sending an order for printing the customized cookbook.

These and other embodiments of the invention are described in further detail below.

### BRIEF DESCRIPTION OF THE DRAWINGS

FIG. 1 is a high-level block diagram of a system for providing a customized cookbook in accordance with an embodiment of the invention.

FIG. 2 is a block diagram of the host site module of the system in accordance with an embodiment of the invention.

FIG. 3 is a block diagram of an order fulfillment flow for providing a customized cookbook or recipe pack in accordance with an embodiment of the invention.

FIG. 4 is a flow chart depicting a method of collecting and parsing recipes in accordance with an embodiment of the invention.

FIG. 5 is a flow chart depicting a method of creating, organizing and customizing a cookbook on the host site in accordance with an embodiment of the invention.

FIGS. 6-17 depict web pages and popup displays of a host website of an embodiment of the present invention, showing various features of the invention.

### DETAILED DESCRIPTION

The present invention is generally directed to a method and system of providing customized publications such as cookbooks, facilitating the organization, presentation and management of user selected information in a customized publication. While the invention is prescribed in connection with the preferred embodiment of customized cookbooks, those skilled in the art will appreciate that the invention as a whole, and that specific aspects of the invention, as described herein, have broader application. Therefore, the following description is not intended to be limiting.

A customized cookbook refers to a publication that includes pages having food-related information, such as recipes, that has been chosen for inclusion by user and that may have been customized by the user. A pack of customized recipes, customized pack, or recipe pack are used interchangeably and refer to a group of one or more loose pages that are purchased and printed in accordance with the present invention and which have food-related information that has been chosen by user. Like a customized cookbook, the content of a recipe pack may be customized by user. In a preferred embodiment, user may order a pack of customized recipes to insert into a previously purchased customized cookbook. Food-related information broadly refers to any content related to food or food preparation. Some examples of food-related information include recipes, food images, ingredient information, nutritional information, food handling information, culinary instructions, information about terminology, cooking tips and techniques, etc.

The customized cookbook or pack may be embodied in an electronic form or in a print form. In the print form, customized cookbooks can be bound in any suitable form, including as a permanently bound “hard-cover” book, a spiral bound book, or binder (such as a multi-ring binder) that can be opened to add or remove pages. Preferably, the customized cookbook or pack is embodied in a viewable electronic form before it is printed. For example, the customized cookbook or pack may be created as a set of digital files, e.g., Adobe® portable document format (“pdf”) files, for previewing before printing. The same, or substantially the same pdf files can also be used for printing. In another embodiment, the customized cookbook or pack can be downloaded, stored and viewed on a user's computing device.

Preferably, customized cookbooks according to the present invention are divided into chapters with divider pages comprising tabs used to separate the chapters. Examples of chapter headings include such items as “brunch and breads,” “appetizers and drinks,” “soups and salads,” “side dishes,” “vegetables,” “pasta, rice and grains,” “fish and seafood,” “meat and poultry,” “desserts and treats,” “everything else.” While the use of these or similar chapter headings in cookbooks is well known, an aspect of the present invention relates to an automated process for assigning recipes to chapters in a customized cookbook, as described in more detail below. For ease of use, recipes contained in a given chapter can be color coded or otherwise coded to quickly convey to the user what type of recipe it is. Such coding can take any suitable form.

The customized cookbook or recipe pack can be configured according to user defined customizations. Of course, the primary customization is the selection of recipes to be included in the cookbook or recipe pack. Examples of other types of user defined customizations include the order of recipes, user modifications to recipes, customizations of the cookbook cover(s), a selection of cookbook binder, etc. As can be seen, customization can be either at the book level, such that it does not affect the appearance of individual pages, (e.g., the order of recipes) or at the individual recipe level, such as the inclusion of user-specific notes or images, which will change the appearance of specific pages.

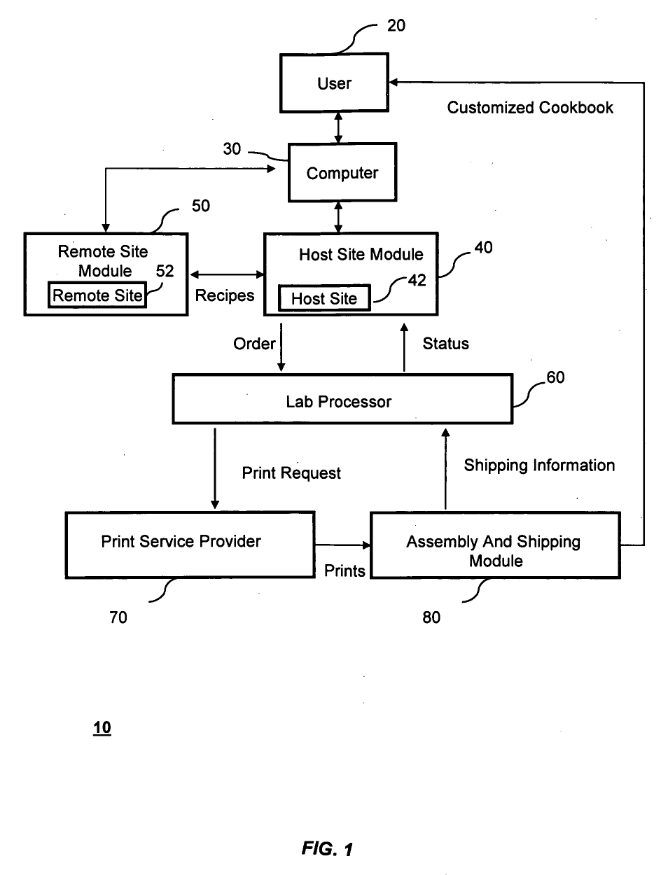

FIG. 1 is a block diagram of an exemplary system for providing a customized cookbook in accordance with an embodiment of the invention. Overall, a user using any suitable computing device 30, such as a personal computer, accesses host site 42 via the internet to shop for, customize, preview and order a customized cookbook or recipe pack. Although one user and one computer 30 are shown in the illustrated embodiment, it will be appreciated that the present invention contemplates that a large number of users will access host site 42. Host site 42 (e.g., a website comprising a plurality of webpages), which is part of a host site module 40, is preferably also in communication with a remote site 52 (e.g., a separately operated website). While one remote site 52 is shown, it will be appreciated that host site 42 may be linked to a plurality of remote sites. As described below, remote site 52 contains content information which may be used in connection with the present invention. In a preferred embodiment, users can directly access remote site 52, for example to access, manage and select content information. It is contemplated that at least some of the users of host site 42 will have registered with and have created accounts on one or more remote sites 52.

Once an order is placed, host site module 40 communicates the order to lab processor 60. While lab processor 60 is preferably maintained as a separate module from host site module 40, it will be appreciated that the two can be combined into one module. As noted, user computer 30 and remote site 52 are linked to host site 42 via the internet or other suitable wide area network (WAN); on the other hand, lab processor 60, if separate from host site module 40, may be linked to the host site module via a local area network (LAN).

Lab processor 60 assembles and organizes the orders, and then passes them along to a print service provider 70. According to a preferred embodiment of the invention, printing, assembly and shipping of customized cookbooks may be handled by independent printing facilities. Such facilities typically will have an assembly and shipping module 80. Thus, print service provider 70 receives print requests from lab processor 60, and passes them to assembly and shipping module 80 which is used in connection with the assembly and shipment of finished products. Assembly and shipping module 80 may also communicate directly with lab processor 60 to send and receive shipping information. Thus, lab processor 60 is also used to receive and send status information about the order back to host site 42.

Generally, user operates computer 30 to access host site 42 and remote site 52. User selects recipes to be included in a customized cookbook and orders the customized cookbook on host site 42. Host site module 40 complies selected recipes from host site 42 and retrieves the selected recipes from remote site 52. Host site module 40 processes the order for the customized cookbook having the selected recipes and sends the order to lab processor 60. Lab processor 60 creates a print request and sends it to print service provider 70. Print service provider 70 prints the recipes based on the print request and sends the prints to assembly and shipping module 80 Assembly and shipping module 80 assembles the customized cookbook and sends shipping information back to lab processor 60 which forwards the status of the order with the shipping information to computer 30 to provide it to user. Assembly and shipping module 80 also ships the customized cookbook to user. In a similar manner, system 10 can provide a pack of customized recipes.

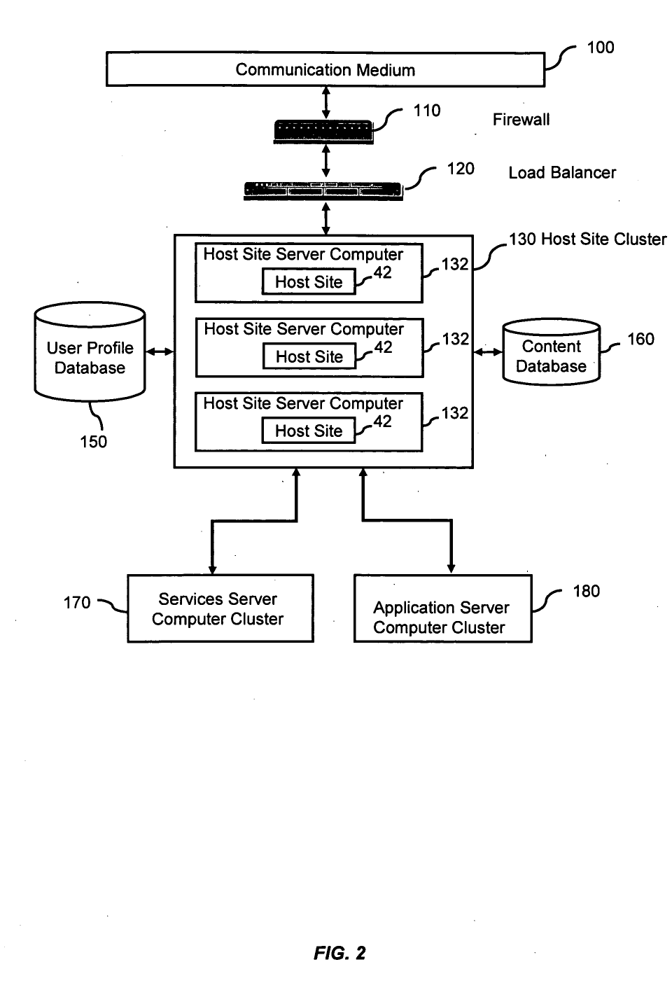

FIG. 2 is a block diagram of host site module 40, in accordance with an embodiment of the invention. As used herein, host site module 40 refers to any group of devices and applications that are used in connection with the operation of host site 42 and making it accessible to the user. Host site 42 comprises a plurality of interrelated web pages and related content such as images, videos, and applications that can be accessed and displayed using a web browser. Thus, host site module includes any hardware and software that provide applications and services on host site 42. In addition, host site 42 allows users to place orders for customized cookbooks and recipe packs, and comprises one or more applications for processing such orders, including payment processing.

Host site module 40 is connected to a communication medium such as a wide area network, e.g., the internet, 100, that is also in communication with computer 30. The host site module preferably comprises a firewall 110 and a load balancer 120, as depicted. Host site module 40 will also typically include a host site cluster 130, a user profile database 150, a content database 160, a services server computer cluster 170, and an application server computer cluster 180. Host site cluster 130 includes a plurality of host site server computers 132, with each host site server computer 132 preferably containing substantially the same website content, i.e., substantially identical versions of host site 42. Host site cluster 130 is in communication with user profile database 150, content database 160, services server computer cluster 170, and application server computer cluster 180. Generally, these elements of host site module 40 are known and need not be described in further detail.

User profile database 150 comprises a database of information such as user profiles, user preferences, user libraries, product data, pending and completed user orders and status of order fulfillment, shipping information, transactional information, pricing information, billing information, contact information, authentication information, address information, user credit allowances, etc. Likewise, content database 160 comprises a database of information for storing food-related information such as recipes, recipe images, and images of pages of the customized cookbook generated for previewing and printing, etc. User profile database 15 and content database 160 may be in a cluster of one or more devices that work together to receive and store information. While databases 150 and 160 are depicted in FIG. 2 as residing on separate computers, it will be appreciated that they can reside on the same computer or computer cluster. In addition, the system preferably comprises a separate services computer cluster 170 provide ancillary services to host site 42. Examples of such ancillary services include processing orders placed on host site 42, creating a “cover” in the electronic form according to user customizations, creating pages in the electronic form according to user customizations, assembling the customized cover and pages, etc. Thus, application server computer cluster 180 provides applications that enable users to customize and preview their cookbooks, to place orders and make payment for customized cookbooks, and to track orders that have been placed. Services server computer cluster 170 may also assemble customized cookbooks in electronic form and send them to lab processor 60. While preferred, it will be appreciated that it is not necessary to isolate these application services on a separate computer.

Likewise, remote site module 50 refers to a group of devices and applications that are used in connection with the operation of remote site 52, including making it accessible to the user. While it is contemplated that remote site 52 may be operated by a third party website operator, such a site also typically comprises a plurality of interrelated web pages and related content and applications that can be accessed and displayed using a web browser. Thus, remote site module 50 includes any hardware and software that provide applications and services on remote site 52. Specifically, remote site 52 is of the type which makes recipes, libraries of recipes, and other food-related information available to the public. Currently, there are many such websites accessible to the public. It is contemplated that in a preferred embodiment, remote site 52 and host site 42 will be accessible from each other using hyperlinks or other pointers on one or more of their respective web pages.

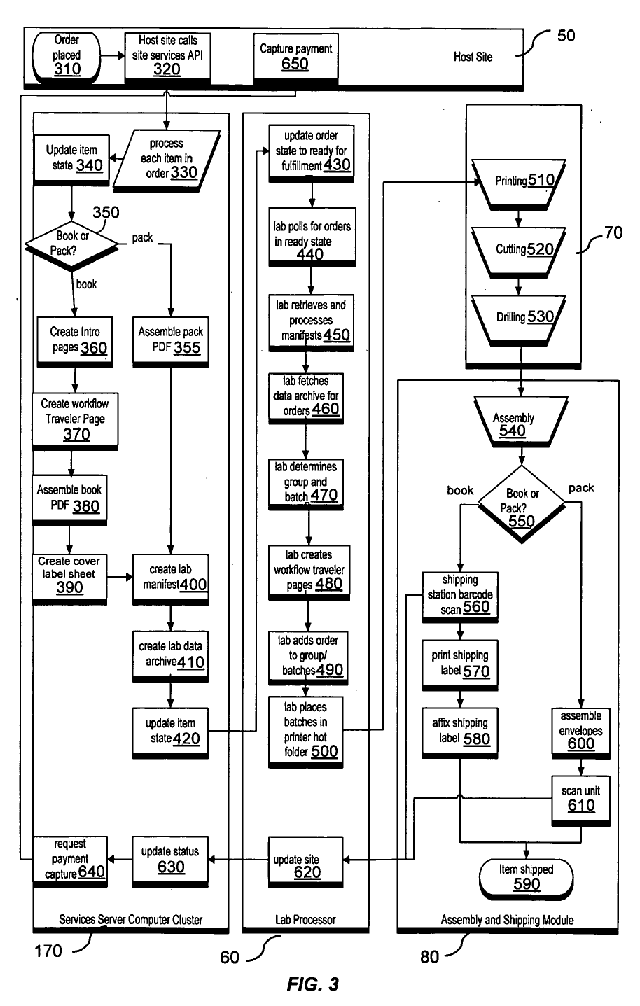

FIG. 3 is a more detailed block diagram depicting the process of fulfillment flow for providing a customized cookbook or recipe pack, in accordance with an embodiment of the invention. The process begins when a user places an order on host site 42 (step 310). Host site 42 requests payment authorization from the user and reserves the amount of the order on, for example, a financial transaction card, such as a credit card or debit card. In response, host site 42 calls an application program interface (API) to process the order (step 320). An order may consist of any combination of customized cookbooks and/or packs of customized recipes. For example, the user may order two items: a customized cookbook as a gift for another user and a pack of recipes to insert into the user's own customized cookbook.

Services server computer cluster 170 processes each item in the order (step 330) and updates the item state (step 340). If the item being processed in the order is a cookbook (step 350), services server computer cluster 170 creates ancillary or “intro” pages (step 360). Predesigned intro pages, customized intro pages or a combination of the two, may be used. Certain ancillary pages, such as a tables of contents and indices, may be created by the system after other user customization but without direct input from the user. Services server computer cluster 170 assembles the cookbook in digital format (e.g., PDF format) (step 380) suitable for use by a printer. The cookbook comprises covers, intro pages, chapter tabs, and recipes, retrieved from content database 16 and incorporating any user customizations. Services server computer cluster 17 creates a cover label sheet (step 39), a lab manifest (step 400) and a lab data archive (step 410) of the assembled pack. Services server computer cluster 170 then updates item state (step 420) to indicate that the item is in a ready state.

Services server computer cluster 170 then creates and attaches a workflow traveler page (step 370), called a “lab shipment page,” to each item of an order. A workflow traveler page refers to a page that has information to assist lab processor 60 with routing through order lab processor 60, print service provider 70, and assembly and shipping module 80. The workflow traveler page includes information such as a list of contents, a barcode, a preview of the cover, a work flow label, or other identifying information. Before the pack or cookbook is shipped to the user, the workflow traveler pages are removed.

If the item being processed in the order is a pack of customized, i.e., user selected, recipes (step 350), services server computer cluster 170 assembles the pack in PDF format (step 355). Optionally, any ancillary content, such as updated table of contents and indices, may also be included in the recipe pack. Services server computer cluster 170 creates cover label sheet (step 390). Services server computer cluster 170 creates a lab manifest (step 400) and creates a lab data archive (step 410) of the recipe pack. Services server computer cluster 170 then updates the item state (step 420) to indicate that the item is ready.

After the items in the order are in the ready state, lab processor 600 updates the order state to indicate that the order is ready for fulfillment (step 430). Lab processor 600 polls for orders that are in the ready state (step 440). In one embodiment, lab processor 600 may select all of the orders in the ready state after the number of orders reaches a predetermined minimum number of orders. Alternatively, lab processor 600 may select all of the orders in the ready state at predetermined time intervals. Or, lab processor 600 may select certain orders in the ready state based on one or more shared characteristics of the orders; for example, all orders using a certain selected cover design, or which are to be shipped to a specific region of the country, may be combined on those bases. Combinations of these embodiments may be used; for example, lab processor 600 may implement a select order routine for each one hundred orders received, but no less than once per day.

Lab processor 60 retrieves and processes manifests (step 450) for the selected orders in the ready state. Likewise, lab processor 60 fetches the data archive for the assembled items in the selected orders (step 460). Lab processor 60 determines a group and a batch (step 47) for each item in the selected orders. Lab processor 60 may organize the items in the selected orders into groups based on a shared characteristic. For example, each of the items in a group may have be a cookbook having the same color or theme. Lab processor 60 then organizes the groups into batches where each batch is a distinct print job. Preferably, lab processor 60 creates and attaches workflow traveler pages to each of the groups and batches. Thus, a “group traveler page” is attached to each of the groups and a a “batch traveler page” is attached to each of the batches (step 49). Lab processor 60 then places batches into a printer hot folder that can be accessed by print service provider 70 (step 500).

As described above, the actual printing and assembly of the customized cookbooks of the present invention may be handled by third parties. Accordingly, the following description of the printing process may vary in particular implementations. Print service provider 70 retrieves and then prints a batch in the printer hot folder (step 510), cuts the prints to page size (step 520), and prepares the printed pages for binding, e.g., drills holes in the printed pages (step 530). The processed prints are then assembled (step 540) and shipped (step 590) to the user or to the user's designee (e.g., a gift recipient). If the item is a cookbook (step 550), a shipping station barcode on the cookbook (step 560) is scanned is used to alert lab processor 60 that the item is ready to be shipped (step 620). The lab processor then confirms shipment ready to the services server computer cluster 170 which updates the status information of the order (step 630) for items ready to be shipped. If there are multiple items in the order and only one is ready for shipment, the status information will indicate that the order is incomplete and that one item is ready to be shipped. In a preferred embodiment, final payment is not requested or made until confirmation that an item is ready for shipment (steps 640, 650). Alternatively, any or all of steps 620, 630, 640 and 650 can be implemented after shipment has been made.

If the item is a pack of recipes (see step 550), the recipe pack is assembled and placed into a shipping envelope (step 600). The envelope is scanned (step 610) and the ready to ship information is conveyed to lab processor 60. Subsequent step are the same as described above in connection with customized cookbooks. However, as noted herein, recipe packs may be prepaid, such that no further payment processing is required.

In one embodiment, the segments parsed from the recipes can be used when connected to host site 42 to automatically generate shopping lists (e.g., a grocery list) for one or more recipes. For example, user may select two recipes in a library and select an automatic shopping list option on host site 42. A shopping list may be created that combines the ingredients and amounts into one list. Host site 42 allows user to preview, modify as desired, and print the shopping list. In some cases, the shopping list may include coupons, advertisements, or other suitable material.

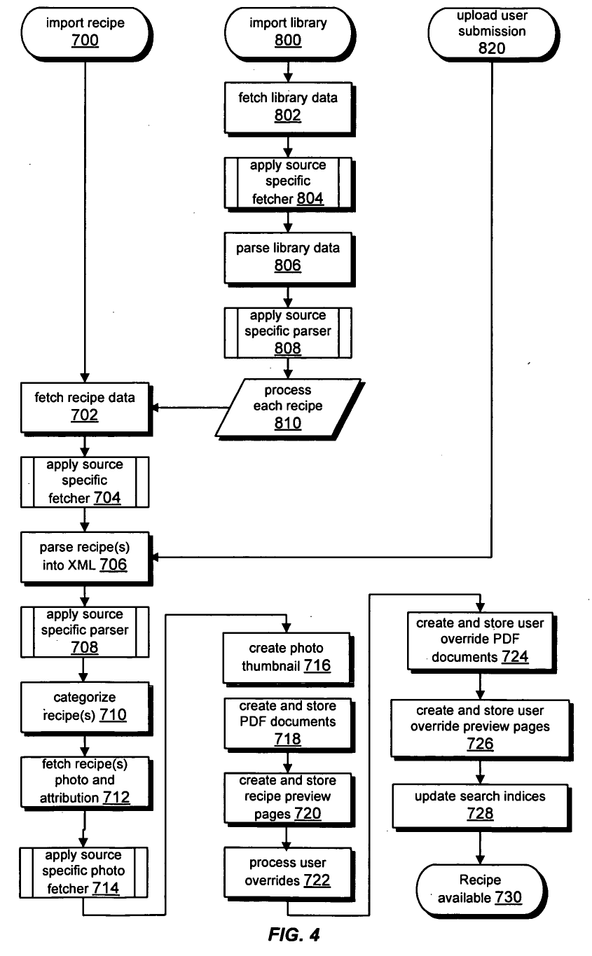

FIG. 4 is a flow chart depicting a method of collecting food related information, such as recipes, from a remote site or directly from a user in accordance with an embodiment of the invention. The collection of recipes is one step in the creation of the customized cookbooks and recipe packs of the present invention. It will be appreciated that the process of customization involves multiple options and is geared to provides users with flexibility. Thus, the process can vary considerably from one user to another. Accordingly, the following discussion is exemplary of a typical process.

For purposes of this description, recipes may be contained in libraries and, thus, the discussion of actions directed to recipes is generally intended to include actions on entire libraries of recipes. Libraries of recipes may be maintained either on host site 42 or remote site 52 or both. Generally, a library is a group of recipes, typically having a common theme. Libraries can be associated with a user or with a source of food information, for example a website that organizes related recipes in groups. A user or other source may have multiple libraries having different characteristics, for example, one library for desserts and another for appetizers. Some food related website allow users to construct, maintain and store recipe libraries online. It is contemplated that users may make their libraries available to other users, as described below, such that such that one user may select recipes or libraries from another user.

Collecting recipes refers to processing recipes, including, for example, retrieving recipes, parsing the recipes, categorizing the recipes, retrieving recipe related auxiliary content such as photos and attribution information, creating and storing documents with the recipes, creating and storing documents with recipes as overridden by the user, and other suitable processes. Typically, host site module 40 performs these processes. In accordance with an embodiment of the present invention, once they have been collected, recipe libraries can be maintained and stored by host site 42 in conjunction with content database 160.

Host site 42 enables user to select recipes to place in their customized cookbook or pack or customized recipes. In one optional approach to adding recipes, host site 42 gives users the option of displaying libraries consisting of lists of recipe titles. The recipe titles are used as links to retrieve recipes from content database 160 or from remote site 52. Thus, on host site 42, a user can create one or more libraries of recipes, import libraries from remote site 52 through host site 42, share libraries with other users of host site 42, or select predefined libraries listed on host site 42. Host site 42 also provides users with the option of allowing them to add recipes by uploading them to host site 42. The user selected recipes form a selection set of one or more recipes for the user's cookbook or pack. This selection set is then stored by host site 42. The host site gives users the option of adding recipes to the selection set whenever they are logged into the site.

According to an embodiment of the present invention, users can import individual recipes or libraries of recipes from remote sites. If a user selects the option of importing an individual recipe from remote site 52 (step 700), the recipe is automatically fetched by host site 42 from remote site 52 (step 720). This is preferably based on the recipe title. If a user selects the option of importing a library of recipes from remote site 52 (step 800), the library data is fetched from remote site 52 (step 820). Library data includes a list of recipe titles in the library, along with the contents of the recipes on the list. A source specific fetcher may be invoked to fetch the recipe (step 740) or the library (step 804). A source specific fetcher is a program that is designed to retrieve data from a specific remote site 52 based on the distinctive characteristics of the data on that remote site. Preferably, the source specific fetcher includes a parser that is designed to parse data from a specific remote site 52 based on the distinctive characteristics of the data on that specific remote site 52 and to transform the data to more usable form. Once the library data is parsed into recipe titles in the library, each recipe in the library can be processed (step 810). Each recipe in the library may be fetched using the recipe title (step 720) using the source specific fetcher (704).

In one embodiment, all of the recipes on a remote site 52 are pre-fetched and stored in content database 16. The fetcher retrieves any new or modified recipes on remote site 52 on a regular basis, and updates content database 16. Such updates may be performed periodically (e.g., on a daily basis). However, although recipes from remote site 52 are locally stored in content database 16, host site may not make such content directly available to users logged into host site 42. Thus, in this embodiment, when user selects the option of importing a recipe or library from remote site 52, the pre-fetched recipes may be retrieved from content database 16.

Another feature of the preferred embodiment of the present invention enables users to select the option of uploading their own recipes(step 820) to the users' libraries on host site 42. Preferably, user recipes can be uploaded in any commonly used electronic file format, including for example ASCII, HTML, XML, Microsoft Word® (“DOC”), PDF, etc.

Once the recipes are fetched or uploaded, they are parsed into a format used by the system, such as extensible markup language (XML) (step 706). A source specific parser may be used to parse the recipes into XML (step 708). At step 706 and/or 708, the recipes are parsed into segments such as recipe title, ingredients, quantity of each ingredient, nutritional content, preparation instructions and other suitable information related to the recipes. A categorization engine, which may be a component of services server computer cluster 170, categorizes the recipes based on their associated segments (step 710). The categorization engine functions to determine a category most closely associated with a recipe based on segments parsed from the recipe. For example, categorization engine may determine that the ingredients and the amounts of the ingredients indicate that the recipe has a high sugar content and therefore may either be considered in the “dessert & treats” or “brunch & breads” categorizes. The categorization may further determine that the title of the recipe includes brunch and therefore, the recipe should be in the “brunch & breads” category. If the categorization engine cannot decide between two categories, the categorization engine may place the recipe in an “everything else” or miscellaneous category.

Any photos and attribution associated with the recipes is also fetched from remote site 52 (step 712). Attribution refers to credit to the author, publisher or originator of the recipe. If necessary, a source specific photo fetcher may be used to fetch the photos associated with the recipes (step 714) and to create image “thumbnails” (step 716).

Digital renderings of printed pages containing the recipes and any associated photos and attributions are created and stored on content database 16 (step 718). Such digital pages may be in the form of PDF files and can be used for printing the customized cookbook or recipe pack. Preferably, two renderings are made of each page, a right-page version and left-page version, and stored in content database 16. As is known in the printing art, the layout of right and left pages differ due to binding and other layout requirements; having two versions available on content database 16 allows services server computer cluster 170 to retrieve the appropriate version and quickly assembly the cookbook or pack for printing without having to reformat an image file for the correct side. Recipe preview pages are also created from the digital pages and stored in content database 16 (step 720). These recipe preview pages are smaller files, similar to thumbnails, that suitable for display in a web browser when a user is logged onto host site 42. Thus, the recipe preview pages allow users to preview their selected recipes.

Any user overrides to recipe pages are then processed (step 722). Thus, processing the user overrides modify the rendered pages. The user modified pages are created and stored on content database 16 (step 724). Likewise, user override preview pages are created and are also stored on content database 160 (step 726). Search indices are updated (step 728). The recipes are then made available (step 730) for previewing and/or for inclusion in a cookbook or recipe pack.

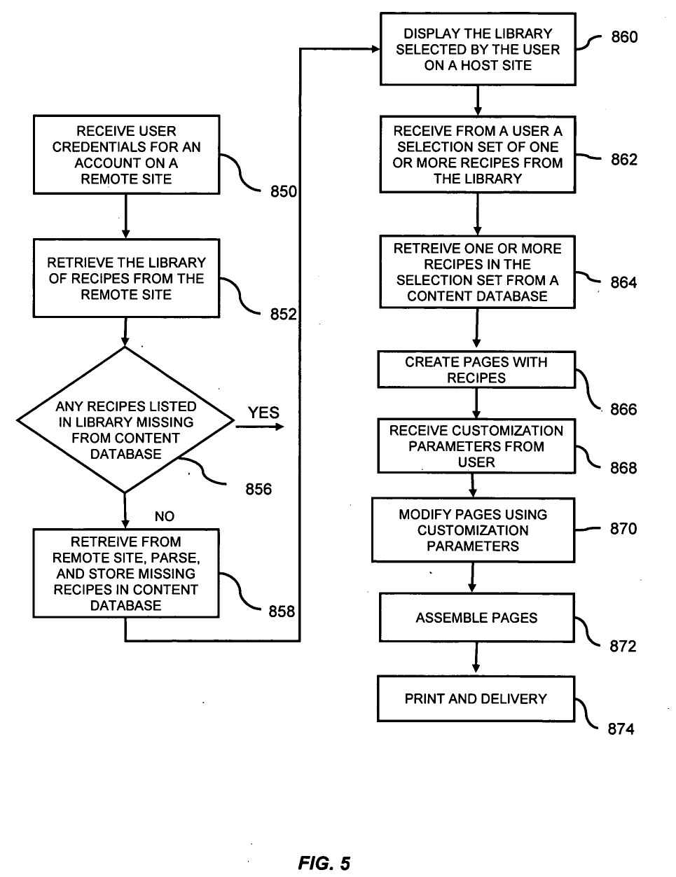

FIG. 5 is a flow chart depicting a method of creating a customized cookbook on host site 42 in accordance with an embodiment of the invention. User first logs on to host site 42. Preferably, this requires the user to register on host site 42 and to create or obtain log on information, such as a user name and password. If the user wants to access a library of recipes from a remote site 52, the user can preferably access information maintained on remote site 52 from a link on host site 42 without leaving host site 42. If access to the user's recipe information on remote site 52 is controlled, host site 42 may require the user to input the user's credentials for remote site 52 (e.g., username and password) to access the user's library on remote site 52 (step 850). The user may then identify the information (e.g., library) to be transferred to host site 42 from remote site 52 (step 852). The transferred library information is parsed, for example, to determine the recipe titles in the library. Host site module 40 checks content database 16 to determine whether it contains the recipes (step 856). If any of the recipes is missing from content database 16, the missing recipes are fetched from remote site 52, parsed, and stored in content database 16 (step 858), as previously described. In addition, recipes can be added to the user's library from stock libraries maintained on host site 42, or by direct uploading, as previously described. The library of recipes selected by user is displayed on a host site 42 page (step 860). As described above, users may have multiple libraries and may add to or delete recipes from libraries from time to time. In addition, users may share access to libraries with others.

Recipes from the user's libraries are then selected to form a selection set of recipes for a customized cookbook or pack of customized recipes (step 862). The selection set may be modified from time to time prior to placement of an order. Host site module 40 retrieves the selected recipes from content database 16 (step 864) and, if necessary, creates rendered pages of the recipes. The recipes are placed into chapters based on information parsed from the recipes and a preview document for viewing online is created using the preview pages described above. Host site 42 allows user to preview the entire cookbook or pack, including the front and back of the cover, the chapter tabs, and the content pages. Host site 42 may include a tool, such as Adobe Flash® Player, to enable the user to “flip” through the pages of the cookbook or pack, e.g., by clicking on the page to turn. At any point prior to placing order, the user may make further customizations the cookbook or recipe pack, i.e., customizations of the recipe pages, the cover, or the order of the recipes (step 868); and the rendered pages are modified using the customization parameters (step 870). The pages are assembled into an electronic version of the cookbook or pack (step 872). After the cookbook or pack is ordered, as described above, host site module 40 sends the assembled electronic version of the cookbook or recipe pack to lab processor 60 to create a print request. Lab processor 60 sends the print request to the print service provider 70. The cookbook or pack is printed and delivered to user (step 874), as described above.

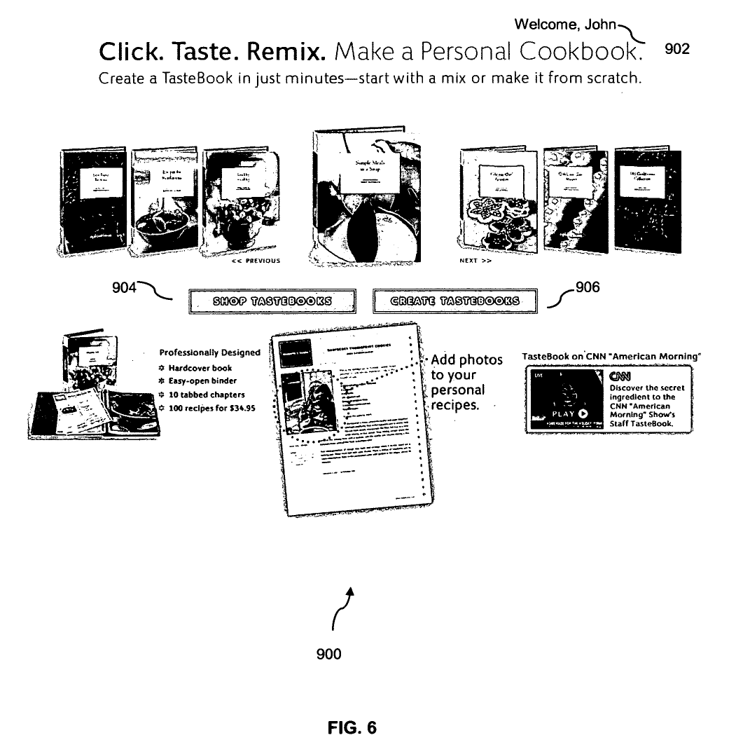

FIGS. 6-17 are screen displays of pages from a website (www.tastebook.com), i.e., an exemplary host site 42, operated by the assignee of the present invention for providing customized cookbooks under the trademark “TASTEBOOK.” Thus, as used in FIGS. 6-17, a “Tastebook” refers to a customized cookbook in accordance with one implementation of the present invention. FIG. 6 shows a webpage 900 on host site 42 depicting a user interface for creating a cookbook. As shown, the user can either select a predefined cookbook or create new customized cookbooks. Host site 42 includes a first icon 904 labeled “Shop Tastebooks” and a second icon 906 labeled “Create Tastebooks”. First icon 904 provides a link that enables a user to select the option of selecting from a plurality of pre-configured cookbooks. Second icon 96 enables user to select the option of creating a new cookbook from scratch. In the illustrated embodiment, the user has already created an account on the host site 42 under a user name of “John” 902.

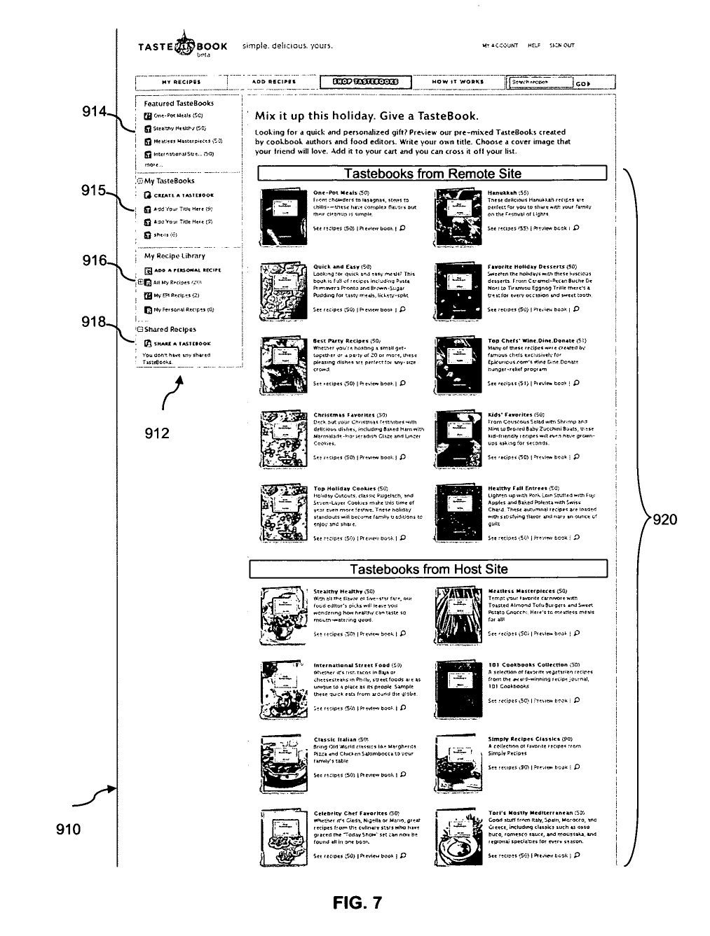

FIG. 7 shows a webpage 910 on host site 42 that is accessed by clicking on first icon 904 (FIG. 6). Webpage 910 enables user to select from a plurality of preconfigured cookbooks. Page 910 includes an area 920 displaying thumbnails of preconfigured cookbooks created and maintained on remote site 52 and on host site 42. Page 910 also includes area 912 including a number of links which are organized as follows. A first set of links 914 provide access to featured preconfigured cookbooks; a second set of links 915 provide access to tools for creating a customized cookbook; a third set of links 916 provide access to tools for maintaining and organizing user selected recipes; and a fourth set of links enables the user to share recipes, libraries and cookbooks. Area 916 may also display information that others have made available to the user.

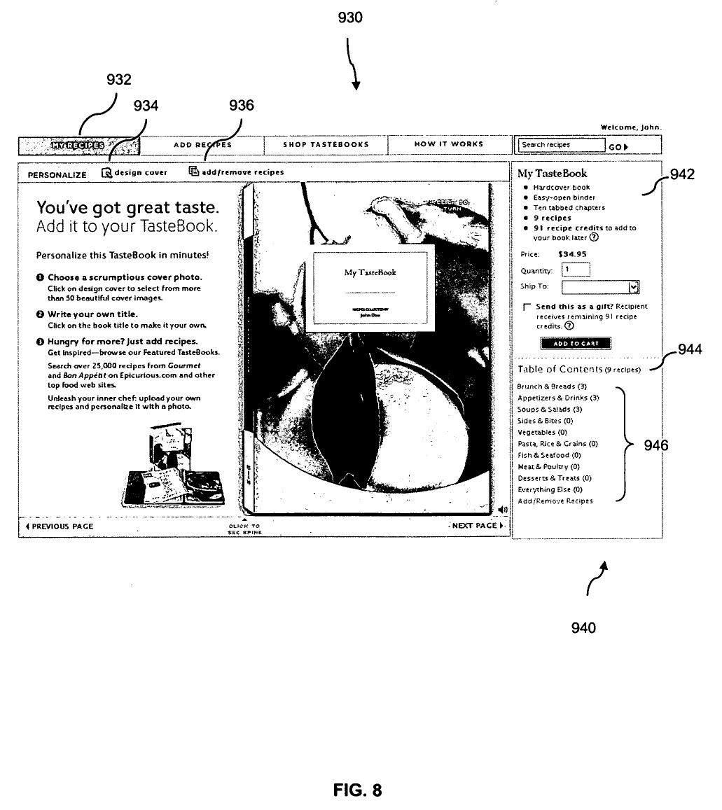

FIG. 8 shows a webpage 930 on host site 42 for creating a customized cookbook. Webpage 930 is accessible from webpage 900 (FIG. 6); webpage 910 (FIG. 7) and other locations on host site 40. Webpage 930 provides users with links to a number of tools for creating and organizing customized cookbooks, for example, links to select cover designs 934, links for adding, removing and organizing recipes 936, 944, 946. In addition, webpage 930 contains an area *** for previewing the cookbook, as described above, and an area 942 for initiating the process for purchasing a customized cookbook.

Webpage 930 also includes a portion 940 that provides information about a user's customized cookbook, for example, information about the title, the table of contents, the chapters, the type of binding, the selected recipes, the number of recipe credits used and remaining, etc. In an exemplary embodiment, user purchases a predefined number of recipe allowances on host site 42, which may correspond to the maximum number of recipes that can be placed in one customized cookbook. Payments for purchases of orders for a customized cookbook or a pack of customized recipes are made over host site 42 using a payment gateway service.

Recipe credits refer to the number of recipe allowances that are available to user for allocation. Recipe credits are those recipe allowances that are not allocated to a customized cookbook. A In the illustrated example, user has a 1 recipe allowances and has allocated 9 recipe allowances to “My Tastebook” and 91 recipe allowances remaining available (91 recipe credits). User can use their recipe allowances by allocated them to their cookbook and purchasing the cookbook. User can save their recipe allowances for a future purchase. Users can also give recipe allowances to another user having an account on host site 42.

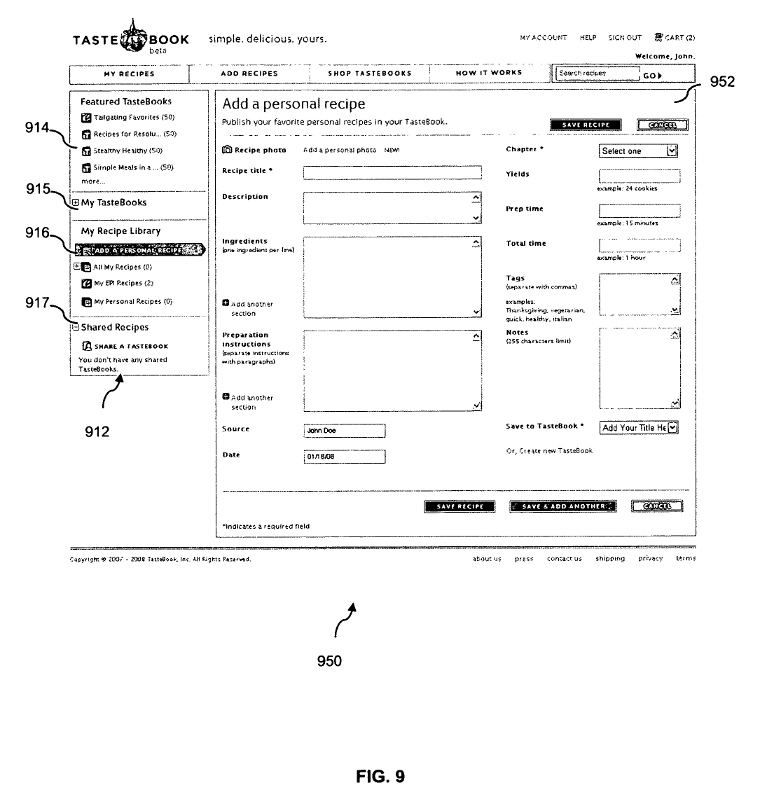

FIG. 9 shows a webpage 950 on host site 42 that allows users to enter their own recipes. Page 950 includes an area 912 including sets of links 914, 915, 916, and 917 for navigating host site 40. Page 950 also includes an area 952 for entering personal recipes. Thus, area 952 allows users to input information about personal recipes, such as recipe title, a brief description of the recipe, ingredients, preparation instructions, the chapter that the recipe will be placed into, the yield of the recipe, the preparation time, the total time, tags, and user notes. Once the information is entered it is uploaded and the recipe is added to the user's library and customized cookbook.

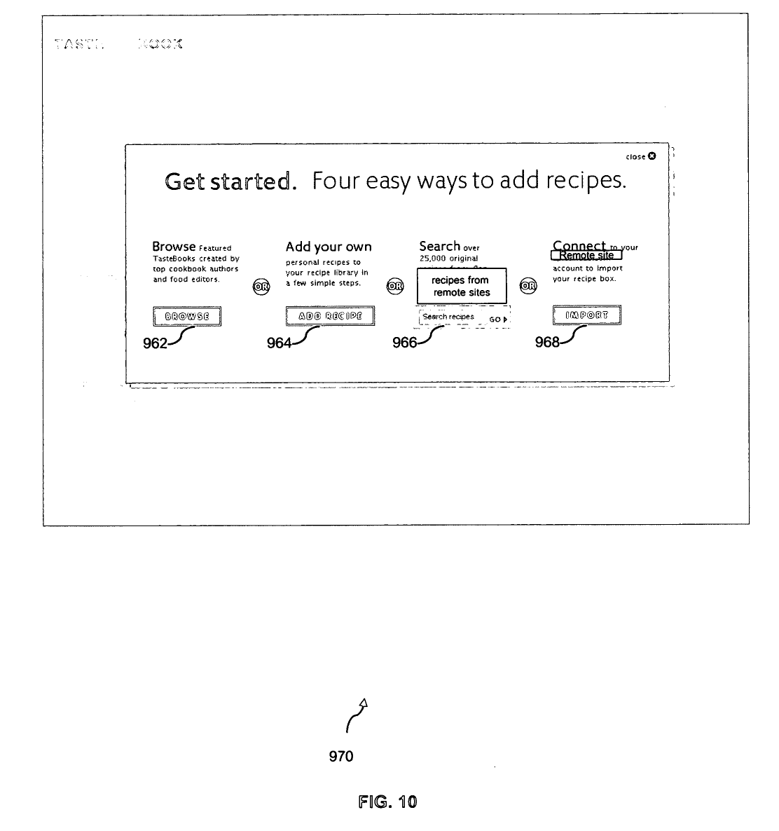

FIG. 10 shows a popup display 970 on host site 42 for facilitating user selection among methods of adding recipes to libraries. Popup display 970 presents icons 962, 964, 966 and 968, which respectively provide links for browsing preconfigured cookbooks, entering recipes, searching remote sites for recipes to import, and for connecting to a remote site 52 to import recipes or libraries of recipes from remote site 52. While popup display 970 provides an easy way for the user to “get started,” it will be appreciated that the various techniques can also be accessed from other locations on host site 42.

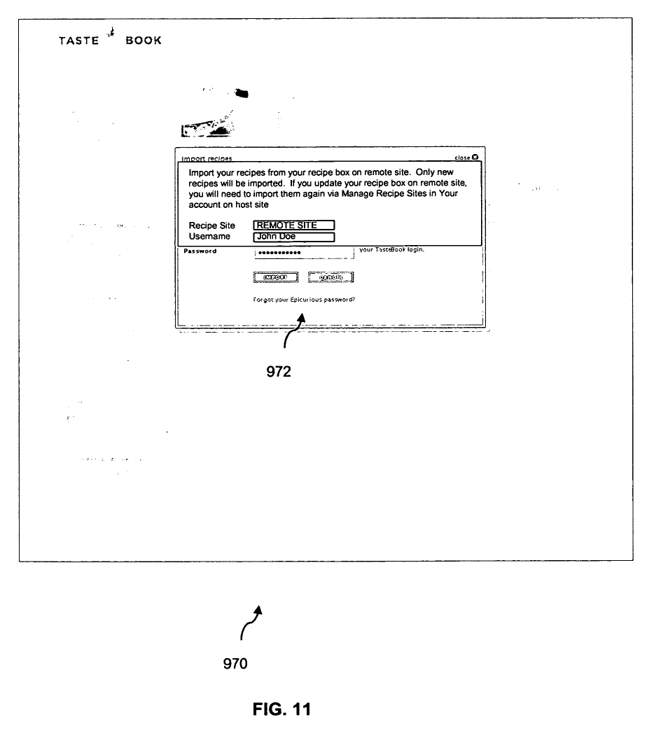

FIG. 11 shows a popup display 970 on host site 42 that provides an interface where user can access an account on remote site 52 by entering a username and password in box 972. This may be required before recipes and libraries of recipes can be imported from remote site 52.

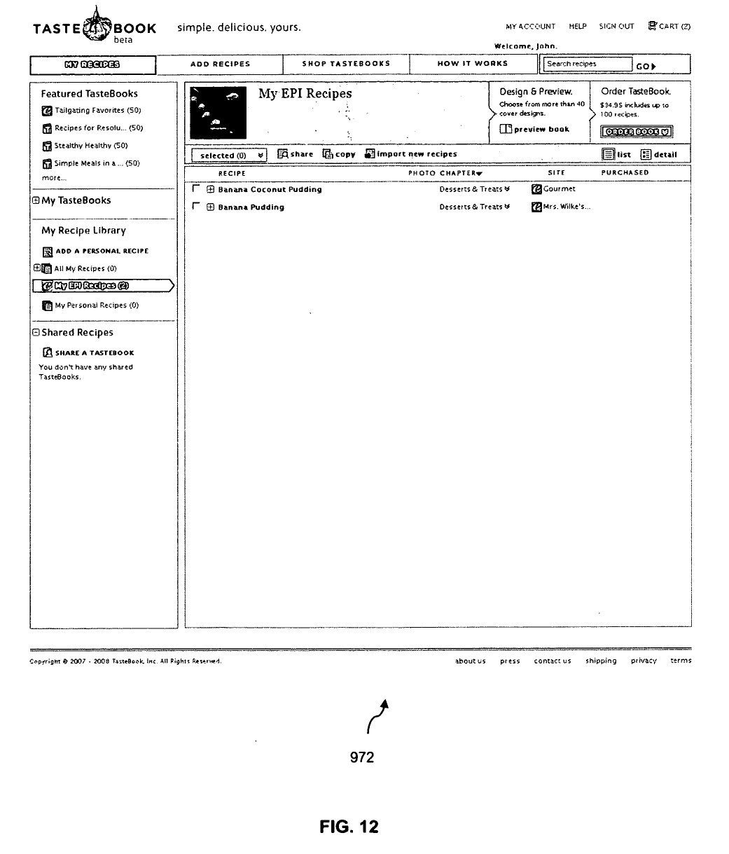

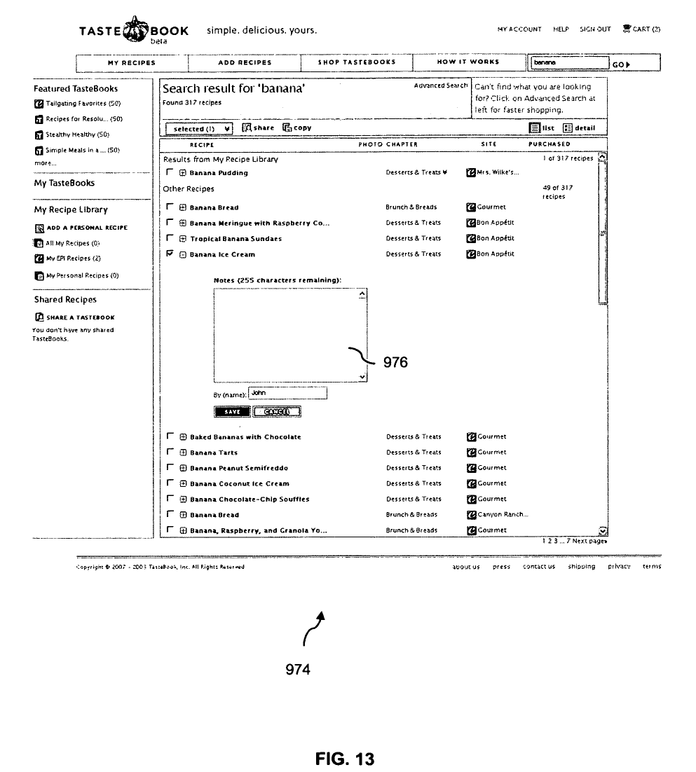

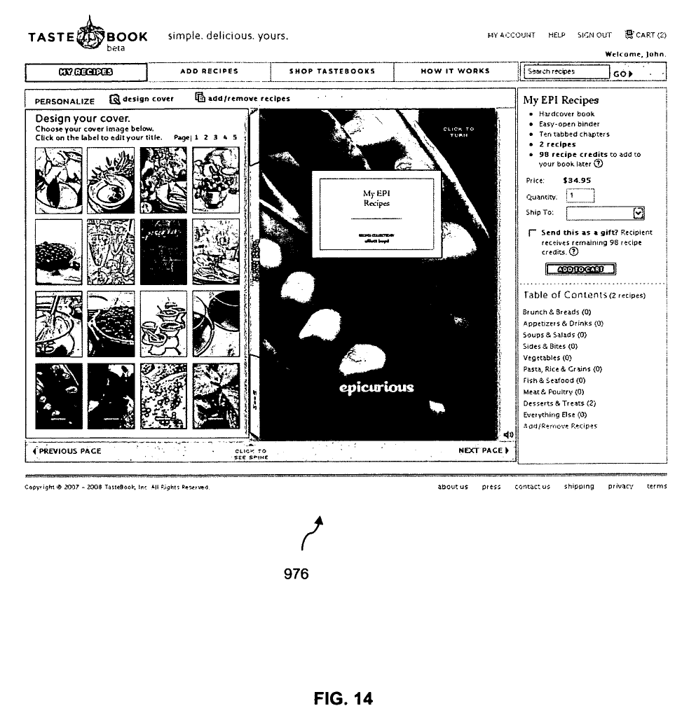

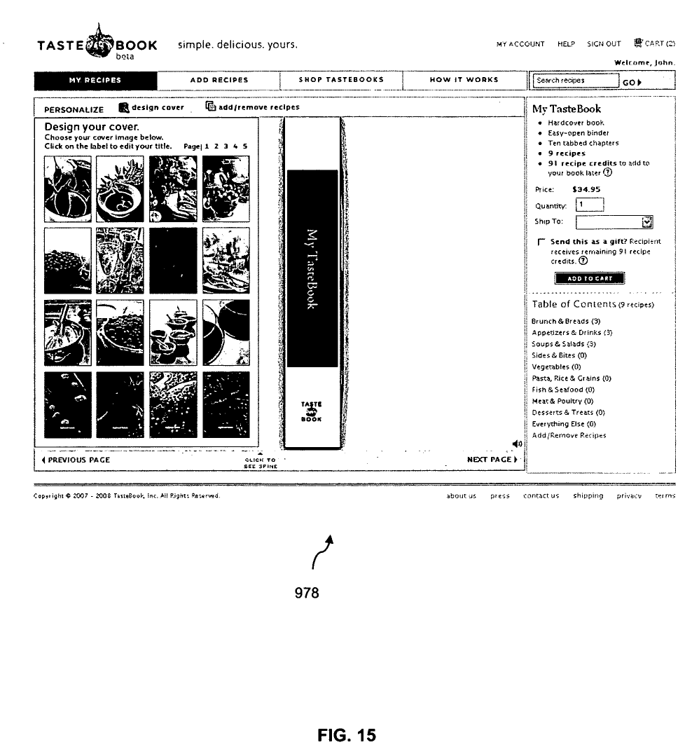

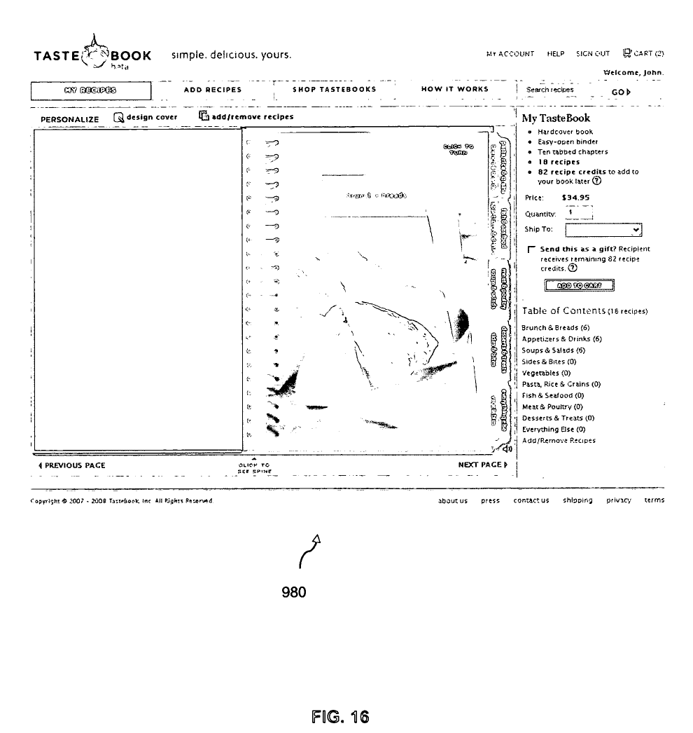

FIG. 12 shows a webpage 972 on host site 42 that lists recipes in a library of recipes imported from a remote site 52. After the library has been imported, the user can select one or more recipes to include them in a customized cookbook or to move them to another recipe library. FIG. 13 shows a webpage 974 on host site 42 that provides an interface that enables user to enter user notes to a recipe. Webpage 974 provides a box 976 where the user can enter notes associated with a specific recipe. FIG. 14 shows a webpage 976 on host site 42 that enables users to customize the covers of their customized cookbook. The user can select a cover image from a set of stock images and can create and edit the title of the customized cookbook. FIG. 15 shows a webpage 978 on host site 42 showing a preview of a spine of a customized cookbook. Webpage 978 is essentially the same as webpage 930 of FIG. 8, with the spine displayed in the preview area. Likewise, FIG. 16 shows a webpage 980 on host site 42 showing a preview of pages of a customized cookbook. Again, webpage 980 of FIG. 16 is essentially the same as webpage 930 showing the operation of the preview area. A user can preview a cookbook by turning the pages using the “next page” and “previous page” icons, or by clicking on the chapter tabs. Preferably, an animation gives the impression of pages turning.

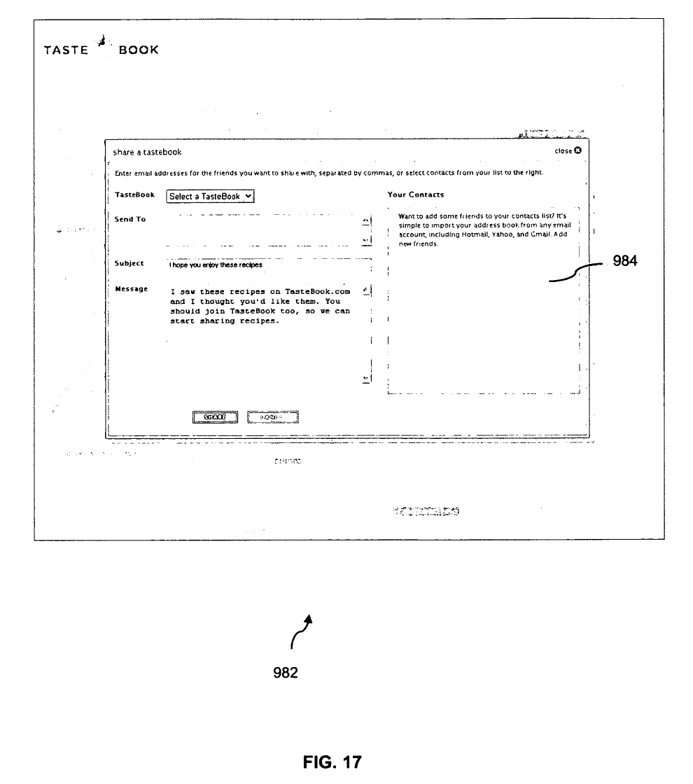

FIG. 17 shows a popup display 982 on host site 42 used to share a user's libraries or cookbooks with other users. Display 982 includes an area 984 that allows the user to select libraries or cookbooks for sharing, enter the email address of the other users, enter a message to the receiving users. Interface area 984 also allows user to manage a contact list.

It should be understood that the present disclosure as described above can be implemented in the form of control logic using computer software in a modular or integrated manner. Based on the disclosure and teachings provided herein, a person of ordinary skill in the art will know and appreciate other ways and/or methods to implement the present disclosure using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the disclosure will become apparent to those skilled in the art upon review of the disclosure. The scope of the disclosure should, therefore, be determined not with reference to the above description, but instead should be determined with reference to the pending claims along with their full scope or equivalents.

One or more features from any embodiment may be combined with one or more features of any other embodiment without departing from the scope of the disclosure.

What is claimed is:

1. A method, comprising:
displaying a list of recipes associated with a library selected by a user;
receiving from a user a selection set of one or more recipes from the list of recipes;
retrieving the one or more recipes in the selection set from a content database;
assembling a customized cookbook having a plurality of pages that include the retrieved one or more recipes; and
sending an order for printing the customized cookbook.

2. The method of claim 1, further comprising:
retrieving the one or more recipes from a remote site; and
storing the one or more recipes to the content database.

3. The method of claim 1, further comprising:
receiving user credentials for an account on a remote site; and
retrieving the library from the remote site using the user credentials.

4. The method of claim 1, further comprising:
receiving a new selection set of recipes from the user; and
adding the recipes in the new selection set to the selection set.

5. The method of claim 1, further comprising:
receiving status information related to the order; and
providing the status information to the user.

6. The method of claim 1, further comprising:
parsing each recipe of the one or more recipes into a plurality of ingredients;
based on the plurality of ingredients, determining a first chapter associated with each recipe, wherein the customized cookbook includes a plurality of chapters having the first chapter; and
placing each recipe into the associated chapter of the customized cookbook.

7. The method of claim 1, further comprising:
parsing at least one recipe of the one or more recipes into a plurality of ingredients and a plurality of amounts, wherein each ingredient of the plurality of ingredients is associated with an amount of the plurality of amounts; and
automatically generating a shopping list with the plurality of ingredients and plurality of amounts.

8. The method of claim 1, further comprising:
receiving a note from the user associated with a first page of the plurality of pages; and
incorporating the note into the first page in a section separate from a recipe of the one or more recipes.

9. The method of claim 1, further comprising:
receiving an image from the user associated with a first page of the plurality of pages; and
incorporating the image into the first page in a section separate from a recipe of the one or more recipes.

10. The method of claim 1, further comprising allowing the user to flip through each page of the customized cookbook on the host site.

11. The method of claim 1, further comprising formatting each of the one or more recipes into two symmetric versions.

12. The method of claim 1, further comprising,
receiving from the user a purchase of a predefined number of recipe allowances; and
receiving instructions from the user to order the customized cookbook associated with a number or recipes.

13. The method of claim 12, further comprising, if a select number of recipes is less than the predefined number of recipe allowances, allowing the user to gift one or more recipe allowances to another user.

14. The method of claim 1, further comprising:
receiving a set of customization parameters from the user; and
customizing the customized cookbook according to the customization parameters.

15. The method of claim 14, wherein the set of customization parameters includes a binder parameter associated with customizing the binder.

16. A method, comprising:
selecting a library of recipes;
choosing one or more recipes from a list of recipes associated with the library of recipes to form a selection set, wherein the one or more recipes in the selection set are stored in a content database; and
ordering a customized cookbook having a plurality of pages that includes the one or more recipes retrieved from the content database.

17. The method of claim 16, wherein the one or more recipes is initially retrieved from a remote site and stored in the content database.

18. The method of claim 16, further comprising entering user credentials on a host site for an account on a remote site, wherein the list of recipes is retrieved from the remote site using the user credentials.

19. The method of claim 16, further comprising selecting one or more recipes from a new list of recipes to add to the selection set.

20. The method of claim 19, further comprising receiving status information associated with the ordering of the customized cookbook.

21. The method of claim 16, wherein each recipe of the one or more recipes is parsed into a plurality of ingredients, wherein each recipe is placed into a chapter of the customized cookbook based on the plurality of ingredients.

22. The method of claim 16, further comprising:
selecting a first recipe from the list of recipes; and
receiving a shopping list associated with the first recipe, the shopping list including a plurality of ingredients parsed from the first recipe, the shopping list further including a plurality of amounts, each ingredient of the plurality of ingredient associated with an amount of the plurality of amounts.

23. The method of claim 22, wherein the shopping list further includes a coupon associated with at least one of the ingredients on the shopping list.

24. The method of claim 16, further comprising entering a note, wherein one of the plurality of pages in the customized cookbook includes the note.

25. The method of claim 16, further comprising entering an image, wherein one of the plurality of pages in the customized cookbook includes the image.

26. The method of claim 16, further comprising flipping through one or more pages of the customized cookbook on the host site.

27. The method of claim 16, further comprising:
purchasing a predefined number of recipe allowances; and
ordering the customized cookbook having the plurality of pages having the one or more recipes associated with a number of recipes.

28. The method of claim 27, further comprising, if the select number is less than the predefined number of recipe allowances, gifting one or more of the purchased recipe allowances to another user.

29. A system, comprising:
a host site server computer having a first computer readable medium having code for displaying a list of recipes associated with a library selected by a user receiving from a user a selection set of one or more recipes from the list of recipes; and
retrieving the one or more recipes in the selection set from a content database;
a services server computer in communication with the host site server computer, the services server computer having a second computer readable medium having code for retrieving the one or more recipes in the selection set from a content database; assembling a customized cookbook having a plurality of pages that include the retrieved one or more recipes; and sending an order for printing the customized cookbook.

30. The system of claim 29, wherein the first computer readable medium further includes code for:
retrieving the one or more recipes from a remote site; and
storing the one or more recipes to the content database.

31. The system of claim 29, wherein the first computer readable medium further includes code for:
receiving user credentials for an account on a remote site; and
retrieving the library from the remote site using the user credentials.

32. The system of claim 29, wherein the first computer readable medium further includes code for:
receiving a new selection set of recipes from the user; and
adding the recipes in the new selection set to the selection set.

33. The system of claim 29, wherein the first computer readable medium further includes code for:
receiving status information related to the order; and
providing the status information to the user.

34. The system of claim 29, wherein the second computer readable medium further includes code for:
parsing each recipe of the one or more recipes into a plurality of ingredients;
based on the plurality of ingredients, determining a first chapter associated with each recipe, wherein the customized cookbook includes a plurality of chapters having the first chapter; and
placing each recipe into the associated chapter of the customized cookbook.

35. The system of claim 29, wherein the second computer readable medium further includes code for:
parsing at least one recipe of the one or more recipes into a plurality of ingredients and a plurality of amounts, wherein each ingredient of the plurality of ingredients is associated with an amount of the plurality of amounts; and
automatically generating a shopping list with the plurality of ingredients and plurality of amounts.

36. The system of claim 29, wherein the first computer readable medium further includes code for receiving a note from the user associated with a first page of the plurality of pages, and wherein the second computer readable medium further includes code for incorporating the note into the first page in a section separate from a recipe of the one or more recipes.

37. The system of claim 29, wherein the first computer readable medium further includes code for allowing the user to flip through each page of the customized cookbook on the host site.

38. The system of claim 29, wherein the second computer readable medium further includes code for formatting each of the one or more recipes into two symmetric versions.

39. The system of claim 29, wherein the first computer readable medium further includes code for:
receiving from the user a purchase of a predefined number of recipe allowances; and
receiving instructions from the user to order the customized cookbook associated with a number or recipes.

40. The system of claim 29, wherein the first computer readable medium further includes code for allowing the user to gift one or more recipe allowances to another user if a select number of recipes is less than the predefined number of recipe allowances.

41. The system of claim 29, wherein the first computer readable medium further includes code for receiving a set of customization parameters from the user, and wherein the second computer readable medium further includes code for customizing the customized cookbook according to the customization parameters.
